(19) United States
(12) Patent Application Publication
(10) Pub. No.: US 2012/0083226 A1
(43) Pub. Date: Apr. 5, 2012

(54) REMOTELY-LOCATED TRANSCEIVER DEVICE AND METHOD FOR MAINTAINING A TRANSCEIVER DEVICE

(76) Inventors: Peter Kenington, Devauden (GB); Eric Westberg, Ulm (DE)

(21) Appl. No.: 12/897,920

(22) Filed: Oct. 5, 2010

(51) Int. Cl. H04B 1/40

(52) U.S. Cl. 455/88

(57) ABSTRACT

A remotely-located transceiver device is disclosed. The remotely-located transceiver device comprises a telecommunications signal transceiver and a service transceiver. The service transceiver is addressable over a short-range wireless link and is adapted to maintain the telecommunications signal transceiver. A method for maintaining a telecommunications signal transceiver is disclosed. The method comprises addressing a service transceiver using a short-range wireless link and interacting with the telecommunications signal transceiver utilising the service transceiver.

### CROSS-REFERENCE TO OTHER APPLICATIONS

None

### FIELD OF THE INVENTION

The field of the invention relates to a remotely-located transceiver device comprising a telecommunications signal transceiver and a service transceiver and to a method for maintaining a telecommunications signal transceiver.

### BACKGROUND OF THE INVENTION

The use of mobile communications networks has increased over the last decade. Operators of the mobile communications networks have increased the number of base stations in order to meet an increased demand for service by users of the mobile communications networks. The operators of the mobile communications network wish to reduce the running costs of the base station. One option to do this is to implement a radio system as an antenna-embedded radio forming an active antenna array. Many of the components of the antenna-embedded radio may be implemented in one or more chips.

In a traditional base-station configuration, the active electronics is situated in a BTS cabin or at the base of the mast. Whenever a suspected faulty unit should be tested or when maintenance operations are required, the suspected faulty unit is replaced by another unit. The suspected faulty unit can thereafter be tested in a laboratory.

Nowadays antenna arrays are used in the field of mobile communications systems in order to reduce power transmitted to a handset of a customer and thereby increase the efficiency of the base station, i.e. the radio station. The antenna array or active antenna system is typically mounted on a mast or tower. The antenna is coupled to the base station (BTS) by means of fibre optics and a power cable. The base station is coupled to a network operated by one or more operators.

Performing maintenance or repair procedures is more complex for an active antenna or a remote radio head mounted on a mast. Whenever a suspected faulty unit mounted on the mast at a site needs to be tested, the whole site must be shut down, a crane needs to be hired and brought to the site and the suspected faulty unit of the antenna system or the whole antenna system must be demounted and replaced by a new unit. The demounted suspected faulty unit is shipped back to the manufacturer for testing and analysis. The whole operation can take many hours during which all of the operators sharing the mast can lose significant amounts of revenue.

This maintenance or repair procedure involves the collaboration of different players involved in providing mobile communications services to subscribers. The different players include, but are not limited to, the equipment manufacturer, the one or more operators of the mobile communications networks, as well as other suppliers such as access nodes suppliers.

Many of the suspected faulty units or antennas are found to be perfectly normal units—or “no fault found”—upon return to the original equipment manufacturer. Many suspected faults in the active antenna indeed do not result from faulty units in the antenna system but rather from misuse of the active antenna. This means that the fault which led to the demounting of the suspected faulty unit occurred elsewhere in the base-station or the mobile communications network. This may also occur in the case of new and complex equipment and systems that require some training before being perfectly understood and operated.

The process of removing the active antenna from the mast and taking the active antenna to a measurement laboratory may also be expensive for the operator and the equipment manufacturer, through the active antenna's warranty provision.

### SUMMARY OF THE INVENTION

The present disclosure discloses a remotely-located transceiver device comprising a telecommunications signal transceiver and a service transceiver. The service transceiver is addressable over a short-range wireless link and is adapted to maintain the telecommunications signal transceiver.

The maintaining of the telecommunications signal transceiver may comprise at least one of: a configuration, a parameter interrogation, a software upload, a diagnosis, a parameter alteration.

In one aspect of the disclosure, the service transceiver is adapted to send instructions to the telecommunications signal transceiver to generate at least one test signal.

In yet another aspect of the disclosure, the service transceiver is adapted to measure power received in a reception band of the telecommunication signal transceiver when the telecommunication signal transceiver receives a test signal

In another aspect of the disclosure, the service transceiver is adapted to be switched into a test mode.

In yet a further aspect of the disclosure, the short range link is adapted to be activated for maintenance operation and to be deactived upon completion of the maintenance operation. The short range link may be a dedicated link for maintenance operation.

The present disclosure also teaches a method for maintaining a telecommunications signal transceiver comprising addressing a service transceiver using a short-range wireless link and interacting with the telecommunications signal transceiver utilising the service transceiver.

In one aspect of the disclosure, the method for maintaining a telecommunications signal transceiver comprises activating the short-range wireless link for maintaining the telecommunications signal transceiver and deactivating the short-range wireless link upon completion of the maintenance of the telecommunications signal transceiver.

The maintaining may comprise at least one of: a configuration, a parameter interrogation, a software upload, a diagnosis, a parameter alteration.

In yet another aspect of the disclosure, the method for maintaining a telecommunications signal transceiver comprises switching the service transceiver into a test mode.

The method for maintaining a telecommunications signal transceiver may comprise sending instructions, by the service transceiver, to the telecommunications signal transceiver to generate at least one test signal.

The present disclosure also teaches a computer program product comprising a non-transitory computer-usable medium having control logic stored therein for causing a computer to manufacture a transceiver device. The transceiver device comprises a telecommunications signal transceiver and a service transceiver. The service transceiver is addressable over a short-range wireless link and is adapted to maintain the telecommunications signal transceiver.

The present disclosure also teaches a computer program product comprising a non-transitory computer-usable medium having control logic stored therein for causing a service transceiver to perform a method for maintaining a telecommunications signal transceiver, the method comprising receiving instructions over a short range link and interacting with the telecommunications signal transceiver.

### DESCRIPTION OF THE FIGS

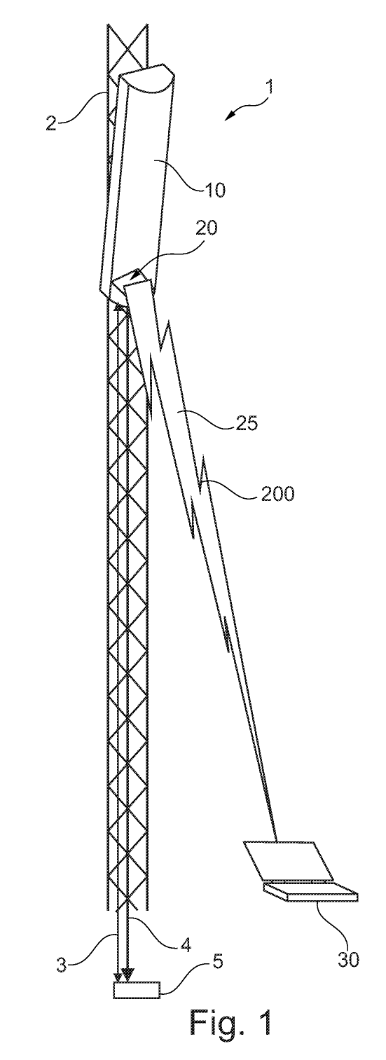

FIG. 1 shows a remotely-located transceiver device comprising a telecommunications signal transceiver and a service transceiver according to the present disclosure.

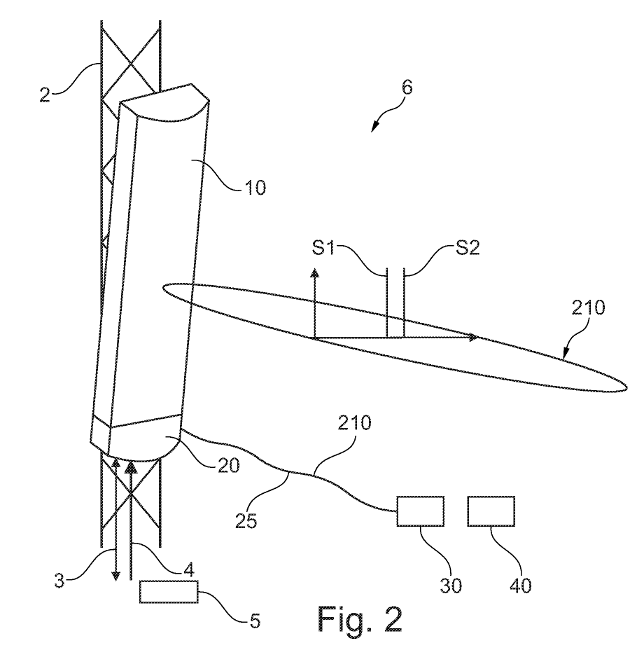

FIG. 2 shows an example of a system adapted to maintain a telecommunications signal transceiver of a remotely-located transceiver device according to the present disclosure.

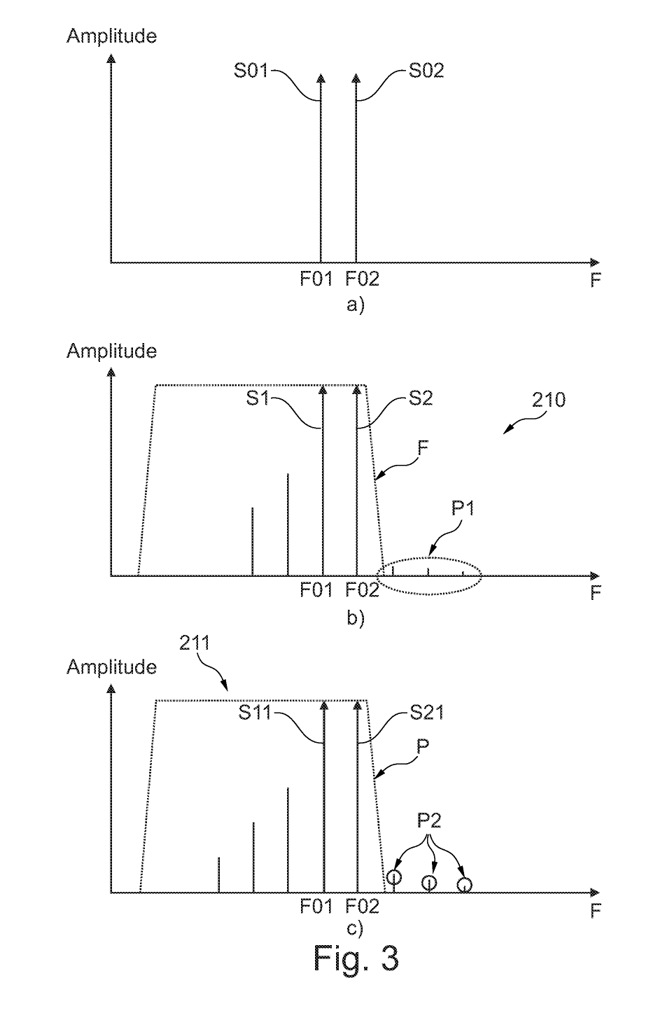

FIG. 3 shows an example of spectra obtained when performing a method for maintaining a telecommunications signal transceiver according to the present disclosure

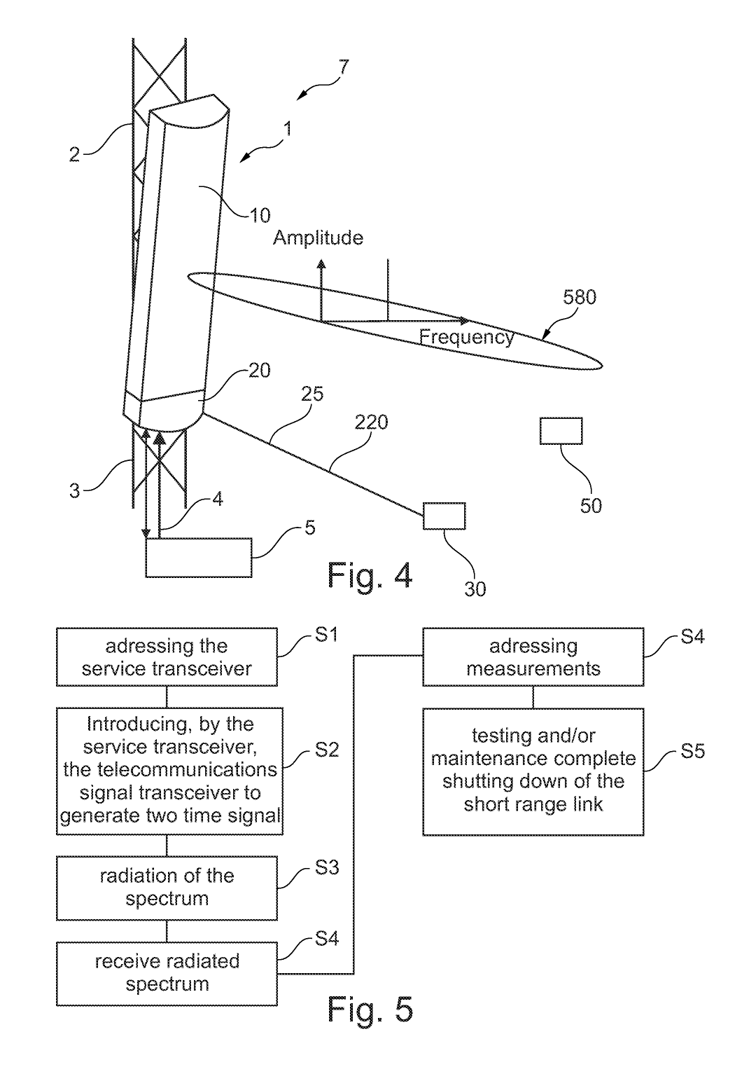

FIG. 4 shows a further aspect of a system adapted to maintain a telecommunications signal transceiver of a remotely-located transceiver device according to the present disclosure.

FIG. 5 shows a method for maintaining a telecommunications signal transceiver according to the present disclosure.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature or features of a different aspect or aspects and/or embodiments of the invention.

FIG. 1 shows a remotely-located transceiver device 1 according to the present disclosure. The remotely located transceiver device 1 can be used in an active antenna system or in a remote radio head.

The remotely located transceiver device 1 is mounted at the top of a mast 2. The remotely located transceiver device 1 is connected to a base station 5 by means of a fiber optic cable 3 and a power cable 4. The fiber optic cable 3 is adapted to carry telecommunication data to and from the base station 5. The power cable 4 is adapted to supply DC or AC power to the remotely located transceiver device 1.

The remotely located transceiver device 1 comprises a telecommunications signal transceiver 10 and a service transceiver 20.

The telecommunications signal transceiver 10 transceivers a telecommunications signal as a payload signal. The telecommunications signal transceiver 10 may be an active antenna array. Typically the telecommunications signal transceiver 10 may comprise a plurality of transmit paths and receive paths. Each of the transmit paths and receive paths are terminated by one of a plurality of antenna elements. The plurality of the antenna elements used in the radio station typically allows steering of a beam transmitted by the antenna array. The steering of the beam includes but is not limited to at least one of: detection of direction of arrival (DOA), beam forming, down tilting and beam diversity. The active antenna array is known in the art and will not be described in detail in the present disclosure.

The service transceiver 20 is adapted to maintain the telecommunications signal transceiver 10. The terms “maintain” or “service” as used in this disclosure means configuration, diagnosis, parameter interrogation, software upload and/or parameter alteration. For example, the service transceiver 20 may also be adapted to upload new software, new software versions or new parameters, to the telecommunications signal transceiver 10. The service transceiver 20 is further adapted to instruct the telecommunications signal transceiver 10 to perform one or more diagnosis tests, an example of which is described later in the present disclosure.

The service transceiver 20 transceivers a service signal 200 to and from a control unit 30 on the ground. The service transceiver 20 is addressable over a short-range wireless link 25 by the control unit 30.

The control unit 30 is adapted to control maintenance operations performed by the service transceiver 20 on the telecommunications signal transceiver 10. The control unit 30 may be a laptop computer or any portable device which can be brought onto a site close to the remotely located transceiver device 1.

The short-range wireless link 25 is preferably a Wi-Fi link based on one of the IEEE 802.11x protocols, but any other short-range communication protocol, such as Bluetooth or ZigBee could be used instead.

It should be understood that the short-range wireless link 25 is used purely for servicing control and maintenance purposes only. The short-range wireless link 25 is not adapted to be used for communications with devices other than the control unit 30 and the service transceiver 20.

The short-range wireless link 25 in the telecommunications signal transceiver 10 is adapted to be enabled and/or disabled remotely using the control unit 30 or from any other control center operated by a network provider operating the remotely located transceiver unit 1. This ensures that the short-range wireless link 25 in the telecommunications signal transceiver 10 only operates when the short-range wireless link 25 needed. This is a precaution against attempts to hack into the active antenna array using a rogue control unit, for example.

The service transceiver 20 is shown on the underside of the telecommunication signal transceiver 10 on FIG. 1. This is not limiting the present disclosure, and the service transceiver 20 could be located anywhere in the remotely located transceiver device 1. The antenna for the service transceiver 20 may be located on the lower face of the telecommunications signal transceiver 10 so that the signals transmitted by the service transceiver 20 propagate predominantly downwards, thereby intentionally limiting the coverage area within which the control unit 30 can be located.

In-field testing of the remotely located transceiver device 1 can be achieved without the need to de-mount the remotely located transceiver device 1. The use of a separate short-range link 25, together with a carefully designed test signal, also allows tests to be performed without the need to stop telecommunications traffic on the remotely located transceiver device 1.

The provision of the service transceiver 20 enables comprehensive installation verification whilst saving the need to ship the remotely located transceiver device 1 back to the manufacturer whenever a fault is thought to occur.

FIG. 2 shows an example of a system 6 adapted to maintain the telecommunications signal transceiver 10 of the remotely-located transceiver device 1 according to the present disclosure. The system 6 is adapted to evaluate intermodulation performance of the remotely located transceiver device 1.

As is well-known in the art, passive intermodulation products can arise from corrosion of the mast 2 or from the remotely located transceiver device 1 (amongst other causes). The metal and its associated corrosion, such as rust, form a rectifier circuit which causes distortion of a small portion of the signal power. This effect is referred to as the ‘rusty-bolt effect’.

The passive intermodulation products can also arise from loose or damaged connections or connectors within the remotely located transceiver device 1 caused by faulty manufacturing or transport damage. It is therefore desirable to perform intermodulation testing for validating the intermodulation performance of the remotely located transceiver device 1 once installed on the mast 2.

One conventional test to test the intermodulation performance is a so-called two tone test signal. The two tone test signal generally comprises the generation of two test signals at two different test frequencies as an input to the unit to be tested. The spectrum radiated by the unit to be tested is analysed. The radiated spectrum comprises two main signals at the two test frequencies corresponding to the two test signals. The radiated spectrum also typically comprises other signals at different frequencies, which are the intermodulation products. The amplitude of the intermodulation products should be kept as low as possible.

In the present disclosure, the two tone test signal is adapted to test the passive intermodulation produced by the remotely located transceiver device 1 and its nearby surroundings, such as the mast 2 or other antennas on the mast (not shown).

The control unit 30 sends, to the service transceiver 20, test information 210 that a two tone test should be performed. The service transceiver 20, upon receipt of the test information 210, instructs the telecommunication signal transceiver 20 to generate the two tone test signals at two test frequencies.

The two tone signals may be generated in a DSP of the telecommunication signal transceiver 10. The spectrum 210 radiated from the remotely located transceiver device 1 is measured by a test device 40 based on the ground. The spectrum 210 comprises signals S1, S2 at the two test frequencies as well as signals at other frequencies corresponding to intermodulation products. Examples of the radiated spectra will be described later with reference to FIG. 5.

The test device 40 is a conventional device for measuring the passive intermodulation products. The test device 40 typically uses a receiving antenna, a band-pass filter and a spectrum analyser. The band pass filter is adapted to isolate the intermodulation products and to attenuate the two main tones of the two tone test. This is necessary to reduce the dynamic range of the measurement signal to a level which will not cause the spectrum analyser to be overloaded, when trying to view the intermodulation products. The spectrum analyser measures the level of the intermodulation products. A pre-amplifier may also be used to increase the level of the intermodulation products. The pre-amplifier can be installed between the band pass filter and the spectrum analyser. The form of the test device 40 is known in the art and will not be described in detail in the present disclosure.

The man skilled in the art will recognize that the passive intermodulation test can be performed whilst the remotely located transceiver device 1 is still mounted on the mast 2.

It will be understood that the remotely located transceiver unit 1 may generate its own (active) intermodulation products at such a power level that these active intermodulation products would mask any passively generated intermodulation products, such as the intermodulation products resulting from the rusty bolt effect. One or more band-pass filters filters out some of the active intermodulation products resulting from the remotely located transceiver unit 1, as will be explained with reference to FIG. 5. An example of the band-pass filter is located at the output of each of the transmit paths of the telecommunication signal transceiver 1 and typically forms a part of the duplex filter required at the antenna end of each transceiver.

FIG. 3 shows different spectra illustrating the two tone test.

FIG. 3a shows the two carriers forming the two-tone test signal, S01, S02 generated at the telecommunications signal transceiver 10. The two carrier signals S01, S02 are generated at two distinct frequencies F01, F02. The two test signals S01, S02 have the same amplitude.

FIG. 3b shows a transmit spectrum 210 transmitted by the telecommunications signal transceiver 10. FIG. 3b also shows characteristics F of the transmit band-pass filter, which is adapted to remove out-of-band signals, in particular the passive intermodulation products resulting from the remotely located transceiver unit 1.

The spectrum 210 comprises the two main transmit signals S1, S2 at the two test frequencies F01, F02 and corresponding to the two test signals S01, S02. The transmitted spectrum 210 also comprises other signals at different frequencies, which are the intermodulation products P1 generated by the telecommunications signal transceiver 10. The intermodulation products P1 of FIG. 2 are residual intermodulation products remaining after the filtering by the transmit band-pass filter F.

It should be noted that the two test signals S01, S02 are generated at one end of the transmit band. This is to ensure that the transmit portion of the transmit band-pass filter removes as much in the way of the active intermodulation products, P1 resulting from the remotely-located telecommunications signal transceiver, 10 as possible.

An alternative option, in the event that the telecommunications signal transceiver 10 has a transmit band with a width equal to a whole allocation of bandwidth for the telecommunications protocol in which the telecommunications signal transceiver 10 is operating (e.g. 60 MHz at 2100 MHz for UMTS), then the two carrier signals S01, S02 could be placed at a substantially very top frequency and a substantially very bottom frequency of the transmit band. This would typically allow the transmit portion of the duplex filter F to achieve its maximum attenuation of the intermodulation products from the telecommunications signal transceiver 10.

FIG. 3c shows the spectrum 211 radiated from the telecommunications signal transceiver 10, including the passive intermodulation products generated by the afore-mentioned ‘rusty bolt’ effect. The active intermodulation products have now been attenuated, as shown in FIG. 3b, to a sufficient degree that these passive intermodulation products will no longer be masked and can be seen on, or recorded by, the test device 40.

The spectrum 211 comprises two main radiate signals S11, S21 at the two test frequencies F01, F02 and corresponding to the two test signals S01, S02. The transmitted spectrum 211 also comprises other signals at different frequencies, which are the passive intermodulation products P2. The passive intermodulation products P2 appear above the residual intermodulation products P1 resulting from the remotely located transceiver unit 1. The passive intermodulation products P2 may result from the ‘rusty bolt’ effect.

FIG. 4 shows an example of a system 7 adapted to maintain a telecommunications signal transceiver 10 of the remotely-located transceiver device 1 according to the present disclosure. The system 7 is adapted to evaluate reception performance of the telecommunications signal transceiver 10 of the remotely located transceiver device 1.

The service transceiver 20 receives, over the short range link 25, an information 220 from the control unit 30 that the service transceiver 20 should be turned into a test mode adapted to test the reception performance of the telecommunications signal transceiver 10.

The service transceiver 20 switches into the test mode upon reception of the information 220.

An intermodulation test signal 500 is generated and radiated by an external test signal source 50. The intermodulation test signal 500 may comprise frequencies corresponding to a particular reception band.

The telecommunication signal transceiver 10 receives the intermodulation test signal 500. The service transceiver 20 in the test mode is adapted to measure power received in the particular reception band of the telecommunication signal transceiver 10.

The result from the power measurements may be compared with pre-determined pass/fail criteria to determine a current status of a receive path of the telecommunications signal transceiver 10. The receive path is also conventionally called the uplink path.

The reception test may determine if a failure of the remotely located transceiver device 1 is due to actual degradation or damage to the remotely located transceiver device 1 itself or due to some other cause in the network path, such as interference caused by other antenna systems mounted on the same, or a nearby, mast.

It is noted that poor receive performance can also be caused by damage to connections or connectors during installation or transport. The reception test may also be used to verify the quality of installation of the remotely located transceiver device 1.

FIG. 5 shows a method for maintaining the telecommunication signal transceiver 10 of the remotely located transceiver device 1.

At step S1, the control unit 30 addresses the service transceiver 20 of remotely located transceiver device 1 using the short range link 25. The control unit 30 may for example send instructions to the service transceiver 20 that the two tone test signal S01, S02 to test the transmission performance of the telecommunication signal transceiver 10 should be performed. It would also be possible for the control unit 30 to send maintenance signals over the short range link 25.

At step S2 the service transceiver 20 instructs the telecommunication signal transceiver 20 to generate the two tone signals S01, S02.

At step S3, the telecommunication signal transceiver 20 radiates the two tone radiate signals S1, S2.

At step S4, the test device 40 on the ground receives the spectrum 201 radiated from the remotely located transceiver device 1. Measurements results are compiled and analysed by the test device 40 at step S5.

At step S6, the control unit 30 sends instructions to the service transceiver 20 that the testing and/or maintenance is complete and that the two tone test signal S01, S02 needs no longer to be generated. The short range link 25 is then shut down.

While various embodiments of the present invention have been described above, it should be understood that they have been presented by way of example, and not limitation. It will be apparent to persons skilled in the relevant arts that various changes in form and detail can be made therein without departing from the scope of the invention. In addition to using hardware (e.g., within or coupled to a central processing unit (“CPU”), micro processor, micro controller, digital signal processor, processor core, system on chip (“SOC”) or any other device), implementations may also be embodied in software (e.g. computer readable code, program code, and/or instructions disposed in any form, such as source, object or machine language) disposed for example in a non-transitory computer useable (e.g. readable) medium configured to store the software. Such software can enable, for example, the function, fabrication, modelling, simulation, description and/or testing of the apparatus and methods describe herein. For example, this can be accomplished through the use of general program languages (e.g., C, C++), hardware description languages (HDL) including Verilog HDL, VHDL, and so on, or other available programs. Such software can be disposed in any known non-transitory computer useable medium such as semiconductor, magnetic disc, or optical disc (e.g., CD-ROM, DVD-ROM, etc.). The software can also be disposed as a computer data signal embodied in a non-transitory computer useable (e.g. readable) transmission medium (e.g., carrier wave or any other medium including digital, optical, analogue-based medium). Embodiments of the present invention may include methods of providing the apparatus described herein by providing software describing the apparatus and subsequently transmitting the software as a computer data signal over a communication network including the internet and intranets.

It is understood that the apparatus and method described herein may be included in a semiconductor intellectual property core, such as a micro processor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalents.

1. A remotely-located transceiver device comprising a telecommunications signal transceiver and a service transceiver, wherein the service transceiver is addressable over a short-range wireless link and is adapted to maintain the telecommunications signal transceiver.

2. The remotely-located transceiver device according to claim 1, wherein the maintaining of the telecommunications signal transceiver comprises at least one of: a configuration, a parameter interrogation, a software upload, a diagnosis, a parameter alteration.

3. The remotely-located transceiver device according to claim 1, wherein the service transceiver is adapted to send instructions to the telecommunications signal transceiver to generate at least one test signal.

4. The remotely-located transceiver device according to claim 1, wherein the service transceiver is adapted to measure power received in a reception band of the telecommunication signal transceiver when the telecommunication signal transceiver receives a test signal.

5. The remotely-located transceiver device according to claim 1, wherein the service transceiver is adapted to be switched into a test mode.

6. The remotely-located transceiver device according to claim 1, wherein the short range link adapted to be activated for maintenance operation and to be deactived upon completion of the maintenance operation.

7. The remotely-located transceiver device according to claim 1, wherein the short range link is a dedicated link for maintenance operation.

8. A method for maintaining a telecommunications signal transceiver comprising:
addressing a service transceiver using a short-range wireless link;
interacting with the telecommunications signal transceiver utilising the service transceiver.

9. The method for maintaining a telecommunications signal transceiver according to claim 7, comprising activating the short-range wireless link for maintaining the telecommunications signal transceiver and deactivating the short-range wireless link upon completion of the maintenance of the telecommunications signal transceiver.

10. The method for maintaining a telecommunications signal transceiver according to claim 7, wherein the maintaining comprises at least one of at least one of: a configuration, a parameter interrogation, a software upload, a diagnosis, a parameter alteration.

11. The method for maintaining a telecommunications signal transceiver according to claim 7, comprising switching the service transceiver into a test mode.

12. The method for maintaining a telecommunications signal transceiver according to claim 7, comprising sending instructions, by the service transceiver, to the telecommunications signal transceiver to generate at least one test signal.

13. A computer program product comprising a non-transitory computer-usable medium having control logic stored therein for causing a computer to manufacture a transceiver device, wherein the transceiver device comprises a telecommunications signal transceiver and a service transceiver, wherein the service transceiver is addressable over a short-range wireless link and is adapted to maintain the telecommunications signal transceiver.

14. A computer program product comprising a non-transitory computer-usable medium having control logic stored therein for causing a service transceiver to perform a method for maintaining a telecommunications signal transceiver, the method comprising receiving instructions over a short range link and interacting with the telecommunications signal transceiver.
